(19) United States
(12) Patent Application Publication
(10) Pub. No.: US 2025/0051059 A1
(43) Pub. Date: Feb. 13, 2025

(54) LEAK-TIGHT CONTAINER COMPRISING A TWO-LAYER LEAK-TIGHT REINFORCING STRIP

(71) Applicant: ABC TRANSFER, CHAMBRAY-LES-TOURS (FR)

(72) Inventors: Jean-Luc SCHNEIDER, SAINT FIRMIN DES PRES (FR); Pierre LEGEAIS, JOUE LES TOURS (FR)

(21) Appl. No.: 18/720,160

(22) PCT Filed: Dec. 16, 2022
(86) PCT No.: PCT/EP2022/086435

§ 371 Date: Jun. 14, 2024

(30) Foreign Application Priority Data
Dec. 17, 2021 (FR) FR2113922

(51) Int. Cl. B65D 33/02; B65D 65/40

(52) U.S. Cl. CPC B65D 33/02; B65D 65/40

(57) ABSTRACT

The invention relates to a leak-tight container comprising a bag (2) formed of a flexible film made of polymer and a leak-tight connection device that is intended to engage with a complementary connection device of a sterile chamber, the connection device comprising a flange (6) to which the bag (2) is bonded, characterized in that the container comprises a two-layer leak-tight reinforcing strip (10) composed of a first layer (11) made of polystyrene and of a second, reinforcing layer (12) made of a material compatible with that of the bag (2) to allow the reinforcing strip (10) to be directly bonded to the bag (2), the rigidity of the second layer being greater than that of the first layer (11), the reinforcing strip (10) being inserted between the flange, which is made of polymer, and the bag such that the first layer (11) is bonded to the flange and the second, reinforcing layer (12) is bonded to the bag.

### TECHNICAL FIELD OF THE INVENTION

The invention relates to the field of containers intended to be connected in a sealed manner to sterile enclosures so as to allow their respective volumes to be placed in communication without contact with said external environment.

The invention relates more particularly to a leak-tight container comprising a bag formed of a flexible polymer film defining an interior volume and a through-opening, and a leak-tight connection device intended to engage with a complementary connection device of a sterile chamber so as to ensure leak-tight communication between the interior volume of said container and that of the chamber, said connection device comprising a flange to which the bag is bonded, said flange delimiting the through-opening of the bag.

The leak-tight container according to the invention is intended in particular, but not exclusively, for the transfer of hazardous products such as certain pharmaceutical, biotechnological, biological, chemical or radioactive products, the transfer of components such as stoppers, bottles, plungers, syringes, etc., the transfer of environmental control devices such as culture medium racks, particle counters, etc., the transfer of cleaning systems, the transfer of liquids, powders, tools, the transfer of waste to the outside of the chamber and/or the transfer of any element necessary for the production or maintenance of the production line.

### STATE OF THE ART

In a known manner, the connection of a sealed container to a sterile enclosure for the transfer of products, without breaking the connection and the seal, is carried out using two connection devices, one equipping the container and the other equipping the enclosure. Each connection device comprises a flange respectively delimiting the through-opening into the internal space of the container or of the chamber, each of the through-openings being closed off by a door. The flange and the door of the container are capable of being connected respectively to the flange and to the door of the enclosure by a bayonet connection and separated from one another under the action of a rotational movement of the associated flange and door of the container with respect to the flange and door of the enclosure to which they are attached.

In the case of flexible film containers, the connection device and the flexible film are assembled by welding the film to the flange. Containers produced in this way do, however, have drawbacks linked to the bonding of the bag to the flange.

When the bags are sterilized in an autoclave, they are subjected to considerable pressure, resulting in high stresses at the bag-to-flange bond, which weakens the bond in terms of strength and leak-tightness. The presence of leakage points cannot therefore be ruled out.

The invention aims to remedy these problems by proposing a leak-tight container with a flexible bag that can be connected to a sterile chamber that can be manufactured simply and quickly, and which has improved mechanical strength and reinforced leak-tightness.

Another object of the invention is to propose a leak-tight container of recyclable flexible bag.

### OBJECT OF THE INVENTION

To this end, the invention proposes a leak-tight container leak-tight container comprising a bag formed from a flexible film made of polymer defining an interior volume and a through-opening and a leak-tight connection device intended to engage with a complementary connection device of a sterile chamber so as to ensure leak-tight communication between the interior volume of said container and that of the chamber, said connection device comprising a flange to which the bag is bonded, said flange delimiting the through-opening of the bag, the container being characterized in that the container comprises a two-layer leak-tight reinforcing strip composed of a first layer of polystyrene compatible with the material of the flange, which comprises at least polyphenylene oxide to allow the reinforcing strip to be directly bonded to the flange, and of a second reinforcing layer made of a material compatible with that of the bag to allow the reinforcing strip to be directly bonded to the bag, and of greater rigidity than the first layer, said reinforcing strip being inserted between the flange and the bag so that the first layer is bonded to the flange and the second reinforcing layer is bonded to the bag.

The term “bonded” is used in this description to mean the permanent assembly of two parts together (in this case, the bag and the flange) while maintaining the integrity of the materials of each part. This term can be used to designate assembly, fastening or bonding using heat welding, welding by heatsealing or thermofusing techniques.

Advantageously, the leak-tight reinforcing strip is thermally bonded to the flange. According to one variant of embodiment, the reinforcing leak-tight strip may also be integrated into the bag.

Advantageously, the reinforcing strip has a thickness of between 50 micrometers and 200 micrometers, advantageously between 60 micrometers and 100 micrometers, and preferably 80 micrometers.

Advantageously, the second reinforcing layer has a thickness greater than or equal to that of the first layer.

Advantageously, the second reinforcing layer comprises polyethylene or is made of polyethylene.

In a preferred embodiment, the flange comprises a blend of polymers, in particular polyphenylene oxide and impact polystyrene.

Advantageously, the bag is advantageously formed from a single- or multi-layer film(s) advantageously comprising polyethylene, and preferably made from a non-woven material comprising polyethylene fibers.

In an advantageous embodiment, the container comprises a protective ring encircling the part of the flange on which the bag is mounted, the latter being engaged between said protective ring and the flange. The protective ring is a part mounted on the flange, preferably clipped onto the flange.

Advantageously, the flexible film and the connection device are made of a bacteriostatic material.

### BRIEF DESCRIPTION OF THE DRAWINGS

Other features and advantages of the invention will emerge from the following detailed description of the invention with reference to the appended figures, and in which:

FIG. 1 shows a schematic front view of a container according to the invention;

FIG. 2 shows a partial longitudinal sectional view of the container of FIG. 1;

FIG. 3 shows a detailed view of the container shown in FIG. 2, with the components shown exploded;

FIG. 4 shows a detailed view of a variant embodiment of the protective ring.

For greater clarity, identical or similar elements of the various embodiments are denoted by identical reference signs in all of the figures.

“Lower” means the parts constituting the container or the ends of these parts furthest from the through-opening of the container, and “upper” means the parts constituting the container or the ends of these parts closest to the through-opening of the container.

### DETAILED DESCRIPTION OF THE INVENTION

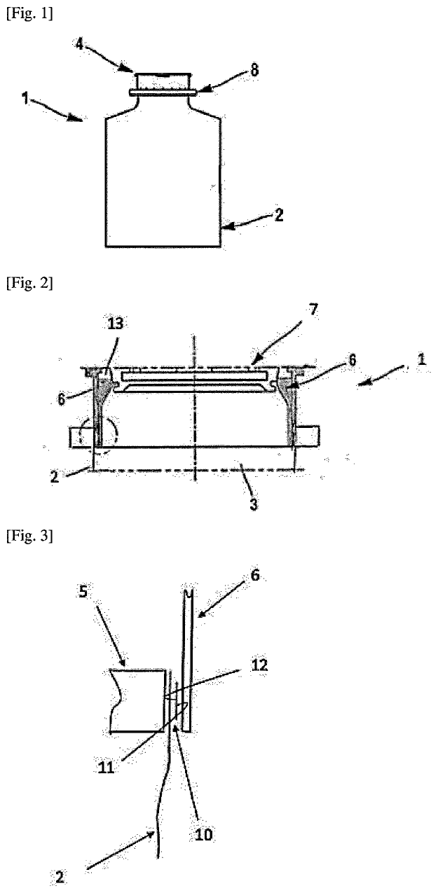

In relation to FIGS. 1 to 4, a container 1 is described according to one embodiment of the invention. The container 1 shown comprises a bag 2 formed from a single- or multi-layer flexible film made of polymer defining an interior volume 3 and a through-opening. It also comprises a leak-tight connection device 4 that is intended to engage with a complementary connection device of a sterile chamber. The connection is made in such a way as to ensure leak-tight communication between the internal space 3 of said container 1 and that of the chamber.

The connection device 4 further comprises a flange 6 and a door 7 removably mounted on the flange 6 so as to close the through-opening. Advantageously, the flange 6 and the door 7 are attached to one another by means of notches and lugs respectively borne by the flange 6 and the door 7. The leak-tightness between the flange 6 and the door 7 is ensured by an annular seal 13 borne by the flange 6, inserted into the space delimited by the flange 6 and the door 7 when the door is in the closing position of the through-opening. Advantageously, the annular seal 13 has a cross-section of a shape matching the area wherein it is housed (L-shaped in the example).

The upper periphery of the flange 6 is provided with an arrangement of lugs forming means of connection to the complementary connection device of the chamber and, at the bottom of the bag, the latter being bonded to the outer wall of said flange, said flange 6 delimiting the through-opening of the bag.

The bag 2 is advantageously formed from a single- or multi-layer film(s) comprising polyethylene. The film is preferably made of a non-woven material comprising polyethylene fibers. The flange is made of polyphenylene oxide.

To reinforce the container's leak-tightness at the weld zone between the bag and the flange, the container 1 has a two-layer leak-tight reinforcing strip 10 inserted between the flange 6 and the bag 2 (FIG. 3). The reinforcing strip 10 consists of a first layer 11 made of polystyrene and a second reinforcing layer 12 made of polyethylene, of a rigidity greater than the first layer. The first layer 11 defines the side of the reinforcing strip 10 facing the flange, while the second reinforcing layer 12 defines the side of the reinforcing strip 10 facing the bag. The first layer 11 is bonded to the flange, while the second reinforcing layer 12 is bonded to the bag.

The reinforcing strip 10 has a thickness of between 25 micrometers and 30 micrometers.

To make the container 1, the bag 2 is bonded flat to the flange 6, the peripheral edge of the bag delimiting the opening being arranged around the flange 6 so as to encircle it externally, with the reinforcing strip 10 inserted between the bag and the flange 6. In order to preserve the integrity of the bag 2 during assembly onto the flange 6, the bag is attached by a thermoforming operation preferably carried out at the limit of the bonding of the flexible film to the flange 6. In a particular configuration, the reinforcing leak-tight strip 10 can be heat-bonded to the flange 6, with the bag 2 positioned directly on the second reinforcing layer 12 of the strip and then bonded. In a further configuration, the reinforcing leak-tight strip 10 can be provided on the inside of the inner peripheral edge of the bag. In this case, the bag is bonded directly to the flange.

A sleeve can also be bonded to the flange at the same time as the bag.

To protect the bag's bond zone, the container 1 advantageously includes a protective ring 5 for the said zone. The protective ring 5, advantageously clipped onto the flange, encircles the part of the flange on which the bag is mounted, the latter being engaged between said ring and the flange.

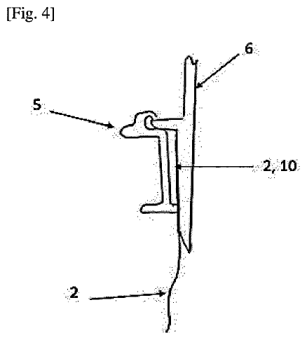

To further enhance the bag's leak-tightness, a protective ring may be provided having an inner peripheral face provided with circumferential scalloping arranged to define, with the outer peripheral face of the flange 6, a compression zone for the portion of the bag engaged between the protective ring 5 and the flange 6 (FIG. 4). The shape of the protective ring 5 and the flange 6 are nominally defined so that the scalloping on said ring interferes with the flange. Such a configuration is shown in FIG. 3. Pressed and exerting a radial force on the outer peripheral face of the internal sleeve 6, the scalloping 14 acts as a seal. In the embodiment shown, the protective ring comprises a single scalloping 14 located at the lower end and extending over the entire circumference of the inner peripheral face of said sleeve. The scalloping is such that when the protective ring 5 is in place on the flange 6, the scalloping 14 is located below the bond line.

Advantageously, the flange 6 comprises an external chamfer of conical shape, made at the lower end of said sleeve to facilitate the threading and the sliding of the flexible film onto the flange.

The flexible film 2 and the connection device 4 are advantageously made of a bacteriostatic material. The seals 8 and 13 are made of a silicone material or other materials minimizing remanence phenomena. Provision may also be made for the seals to be made of a bacteriostatic material.

The invention is described in the foregoing by way of example. It is understood that a person skilled in the art is able to produce different variant embodiments of the invention without departing from the scope of the invention. In particular, the container described is not limited to the connecting device arrangement shown. Similarly, although the container is shown with a protective ring 5, this is optional. Furthermore, if a protective ring is present, it is not limited to the configuration shown.

1. A leak-tight container comprising a bag formed of a flexible film made of polymer defining an interior volume and a through-opening, and a leak-tight connection device intended to engage with a complementary connection device of a sterile chamber so as to ensure leak-tight communication between the interior volume of said container and that of the chamber, said connection device comprising a flange to which the bag is bonded, said flange delimiting the through-opening of the bag, wherein the container comprises a two-layer leak-tight reinforcing strip composed of:
a first layer made of polystyrene compatible with the material of the flange, which comprises at least polyphenylene oxide to allow the reinforcing strip to be directly bonded to the flange, and
a second reinforcing layer made of a material compatible with that of the bag to allow the reinforcing strip to be directly bonded to the bag, and of greater rigidity than the first layer,
said reinforcing strip being inserted between the flange and the bag such that the first layer is bonded to the flange and the second reinforcing layer is bonded to the bag.

2. The container according to claim 1, wherein the reinforcing leak-tight strip is a strip thermally bonded to the flange.

3. The container according to claim 1, wherein the reinforcing leak-tight strip is integrated into the bag.

4. The container according to claim 1, wherein the reinforcing strip has a thickness of between 50 micrometers and 200 micrometers, advantageously between 60 micrometers and 100 micrometers, and preferably 80 micrometers.

5. The container according to claim 1, wherein the second reinforcing layer has a thickness greater than or equal to that of the first layer.

6. The leak-tight container according to claim 1, wherein the second reinforcing layer is made of polyethylene.

7. The container according to claim 1, wherein the bag is formed from a single- or multi-layer film(s) comprising polyethylene.

8. The container according to claim 1, wherein the container further comprises a protective ring encircling the part of the flange on which the bag is mounted, the bag being engaged between said protective ring and the flange.

9. The leak-tight container according to claim 8, wherein the protective ring is clipped onto the internal sleeve.
